(19) United States
(12) Patent Application Publication
(10) Pub. No.: US 2023/0234317 A1
(43) Pub. Date: Jul. 27, 2023

(54) METHOD AND APPARATUS FOR FORMING A COVERED CARDBOARD CONTAINER AND CORRESPONDING CONTAINER TEMPLATE

(71) Applicant: JASA Group B.V., Alkmaar (NL)

(72) Inventors: Jacobus Cornelis Rasser, Amsterdam (NL); Hendrik Jan van den Berg, Hoofddorp (US)

(73) Assignee: JASA Group B.V., Alkmaar (NL)

(21) Appl. No.: 18/002,721

(22) PCT Filed: Jun. 30, 2021
(86) PCT No.: PCT/EP2021/067950

§ 371 Date: Dec. 21, 2022

(30) Foreign Application Priority Data
Jul. 1, 2020 (NL) 2025970

(51) Int. Cl. B31B 50/46; B31B 50/78; B65B 25/04; B65B 43/28; B65B 5/02; B31B 50/06

(52) U.S. Cl. CPC B31B 50/46; B31B 50/784; B65B 25/04; B65B 43/285; B65B 5/024; B31B 50/06; B31B 2100/0024

(57) ABSTRACT

A method is disclosed for forming a covered cardboard container from a single template. The template is configured such that, when side panels are lifted off the top face of the template, a front panel and rear panel are lifted together with the side panels. The container is formed when the two side panels, the front panel and the rear panel are all in a substantially vertical position.

After the container is formed it is filled with product, such as apples, pears, avocados, and the like. The container has two top panels that are folded over the product and adhered to one another to form a lid. Score lines in the top panel allow the container to accommodate products of varying size.

### BACKGROUND OF THE INVENTION

### 1. Field of the Invention

The invention relates generally to a method for forming a covered cardboard container, and to a cardboard container produced by the method.

### 2. Description of the Related Art

Certain retail items are often sold as a package containing a specific count of identical or related items, for example 3, 4, 6, 8, etc. items packaged together. Examples include jars of preserve or condiments, cans of beverage, etc. The term “6-pack” has become commonplace, in particular with reference to cans or bottles of beer.

Such packages are increasingly finding application for produce items, such as apples, pears, tomatoes, and the like. Produce items are more fragile than are cans, bottles, and jars, and therefore require more protection.

In many cases produce items are packaged on a pre-formed tray, which is covered with a plastic foil after the produce items are placed on the tray. Such tray may be formed of a polymer material, for example polyethylene or polystyrene. There is a trend towards the use of renewable packaging materials. Molded pulp trays increasingly replace the polymer trays. In certain cases the produce-filled trays are covered with a polymer film, which detracts from the sustainability message intended to be sent by the molded pulp tray.

Instead of a polymer outer wrap, a cardboard sleeve may be used as the outer packaging material. Such sleeves add complexity to the packaging process. Sleeved packages may use shallow cardboard boxes as the inner package, replacing molded trays. Sleeved packages have the disadvantage of requiring the handling of two components for forming the package. Trays have the additional disadvantage of being bulky, due to their three-dimensional shape, and being difficult to handle by packaging machinery.

Thus, there is a need for a method for forming a covered cardboard container from a single template. There is a further need for such method that is capable of handling produce items that may vary in shape and dimension.

### BRIEF SUMMARY OF THE INVENTION

The present invention addresses these problems by providing a method for forming a covered cardboard container, filled with a product, said method comprising the steps of:
providing a container template as defined herein;
placing the container template in a receiving area of a packaging machine;
lifting the transverse edge of the front panel and the transverse edge of the rear panel off the top face of the container template, thereby folding upward the first side panel along the first score line and the second side panel along the second score line;
pushing the first side panel and the second side panel toward the longitudinal axis of the container template to a substantially vertical position, thereby forming a container preform;
placing the product inside the container preform;
folding the first top panel along the third score line toward the longitudinal axis of the container template and folding the second top panel along the fourth score line toward the longitudinal axis of the container template, thereby creating an area of overlap where a portion of the first top panel overlaps with a portion of the second top panel;
securing the first top panel to the second top panel in the area of overlap.

Another aspect of the invention is a cardboard container formed by the method of the present invention.

Yet another aspect of the invention is an apparatus for carrying out the method of the present invention.

### DETAILED DESCRIPTION OF THE INVENTION

The following is a detailed description of the invention.

### Definition

The term “cardboard” as used herein means a sheet of material made of cellulose fibers, having a stiffness greater than that of paper. The term encompasses materials that are generally used in packaging. The term encompasses paperboard, cardboard, and corrugated cardboard.

### Template

An important aspect of the method of the present invention is that it forms a covered cardboard container from a single template. This significantly reduces complexity as compared to sleeved containers of the prior art. Although the template may vary in thickness in specific areas, it is substantially flat. This greatly reduces storage volume of the packaging material as compared to the prior art preformed tray/sleeve combination.

The method of the present invention requires a container template having a top face and a bottom face, a longitudinal axis, and a transverse axis perpendicular to the longitudinal axis;

a front panel and a rear panel folded back onto the top face, each panel having a transverse edge parallel to the transverse axis, the panels being sized and configured so that a central area of the top face of the container template remains uncovered by the panels, said central area including a point where the longitudinal axis and the transverse axis intersect;
the top face having a first and a second score line, said first and second score line being parallel and equidistant to the longitudinal axis and together defining a bottom panel;
the top face further having a third score line and a fourth score line, said third and fourth score line being parallel and equidistant to the longitudinal axis, the first and third score line together defining a first side panel and the second and fourth score line defining a second side panel, the third score line defining a first top panel extending outwardly from the third score line, and the fourth score line defining a second top panel extending outwardly from the fourth score line;
the front panel and the rear panel each having a first and a second diagonal score line, each first diagonal score line extending outwardly from the first score line of the bottom panel at a 45 degree angle, and each second diagonal score line extending outwardly from the second score line of the bottom panel at a 45 degree angle, each diagonal score line defining an edge area adhered to the top face of the container template.

The container template may further comprise one or more longitudinal score lines within each top panel for articulating each panel.

The container template may further comprise holes in the bottom panel to facilitate manipulation of the rear panel and the front panel during formation of a container from the container template. Preferably the holes in the bottom panel are positioned along the longitudinal axis; each hole intersects with the transverse edge of one of the front and rear panels.

The top panels may contain finger holes to facilitate hand carrying of the finished container.

### The Method

In its broadest aspect the present invention relates to a method for forming a covered cardboard container, filled with a product, said method comprising the steps of:
a. providing a container template as defined herein;
b. placing the container template in a receiving area of a packaging machine;
c. lifting the transverse edge of the front panel and the transverse edge of the rear panel off the top face of the container template, thereby folding upward the first side panel along the first score line and the second side panel along the second score line;
d. pushing the first side panel and the second side panel toward the longitudinal axis of the container template to a substantially vertical position, thereby forming a container preform;
e. placing the product inside the container preform;
f. folding the first top panel along the third score line toward the longitudinal axis of the container template and folding the second top panel along the fourth score line toward the longitudinal axis of the container template, thereby creating an area of overlap where a portion of the first top panel overlaps with a portion of the second top panel;
g. securing the first top panel to the second top panel in the area of overlap.

The container template referred to in step a. is as described above in the section “Template.”

Templates are generally stored in stacks. A stack of templates may be placed next to a packaging machine, within reach of a robot arm that is designed and programmed to place one or more templates at a time within a receiving area of the packaging machine. In an alternate embodiment templates are fed from a stack into the packaging machine by a stack feeder.

Forming the template into a three-dimensional shape begins by lifting the transverse edges of the front and rear panels off the top face of the template. The transvers edges of these panels may have become pressed into the top face of the template, in particular if templates have been stacked upon one another for any length of time. As a result some affirmative action is required to lift the front and rear panels off the top face of the template.

In an embodiment the front and rear panels are lifted off the top face of the template by engaging these panels, for example with suction cups, lifting the suction cups, while preventing upward movement of the central portion of the template.

In another embodiment the template is placed in a substantially horizontal position whereby the side panels are supported and the central portion is not supported. The pushing down action forces the side panels upward. Due to the design of the template the upward movement of the side panels lifts the front and rear panels off the top face of the template.

Next, the side panels are pushed inward until they reach a substantially vertical position. This action moves the front and rear panels into a substantially vertical position at the same time. The resulting configuration is referred to as a container preform.

The contained preform is now ready to receive the product to be held in the container. For placing product into the container preform it may be desirable to fold the top panels outward. Product may be placed into the container preform by any means know in the art. In general, product will be dropped into the container preform by gravity. Examples of products include produce items, such as apples, pears, avocados, peaches, plums, cherries, and the like. Other examples of products include toys, such as building blocks, pieces of soap, candles, etc.

After the product is placed into the container preform, the top panels are folded inward into an abutting or overlapping arrangement. The container is than closed by adhering the free edges of the top panels to each other, for example by adhesive, adhesive tape, stitching, punching, etc.

Produce items, being natural products, vary in size and shape. It is important for the cardboard container to be able to accommodate size differences within preset limits. This is accomplished in the method of the present invention by allowing the area of overlap created in step f. to vary. Optional longitudinal score lines within the top panels provide additional size flexibility.

### BRIEF DESCRIPTION OF THE FIGURES

FIG. 1 is a top view of a template for use in the method of the present invention with the side panels in extended position.

FIG. 2 is a top view of the template of FIG. 1 with the front and rear panels folded back and adhered to the top face of the template. The depicted template is ready for use in the method of the invention.

FIG. 3 is a top view of an alternate template for use in the method of the present invention with the side panels in extended position. After the front and rear panels are folded back and adhered to the top face of the template, in a manner analogous to FIG. 2, the template will be ready for use in the method of the invention.

FIGS. 4A through 4E show consecutive stages of the formation of a container.

FIG. 4A is a top view of the template of FIG. 3 with the front and rear panels folded back and adhered to the top face of the template. The depicted template is ready for use in the method of the invention.

FIG. 4B shows the template for FIG. 4A after the front panel and the rear panel have been lifted off the top face of the template.

FIG. 4C shows the template of FIG. 4A with the front and rear panels and the side panels in substantially vertical position. This configuration is referred to as a container preform.

FIG. 4D shows the container preform of FIG. 4C with the top panels folded outward so that the container preform may receive product.

FIG. 4E shows the container after the product (not shown) has been introduced and the container has been closed.

FIG. 5A shows an apparatus for forming and filling a container of the invention.

FIG. 5B shows a portion of the apparatus of FIG. 5A at a point in time when a robot arm engages templates in two stacks.

FIG. 5C shows the portion of the apparatus depicted in FIG. 5B, at a point in time when the front and rear panels are being lifted of the top faces of the templates.

FIG. 5D shows the portion of the apparatus depicted in FIGS. 5B and 5C at a point in time when the container preforms have been formed.

### DESCRIPTION OF ILLUSTRATIVE EMBODIMENTS/EXAMPLES

The following is a description of certain embodiments of the invention, given by way of example only.

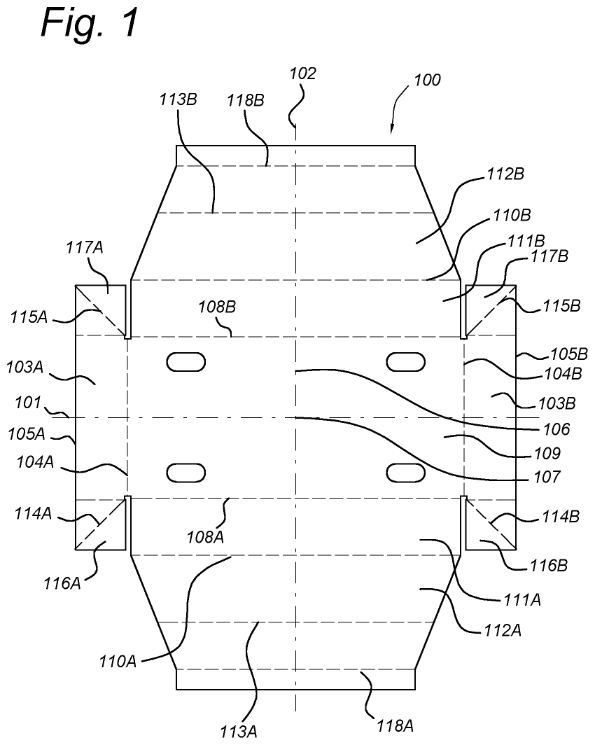

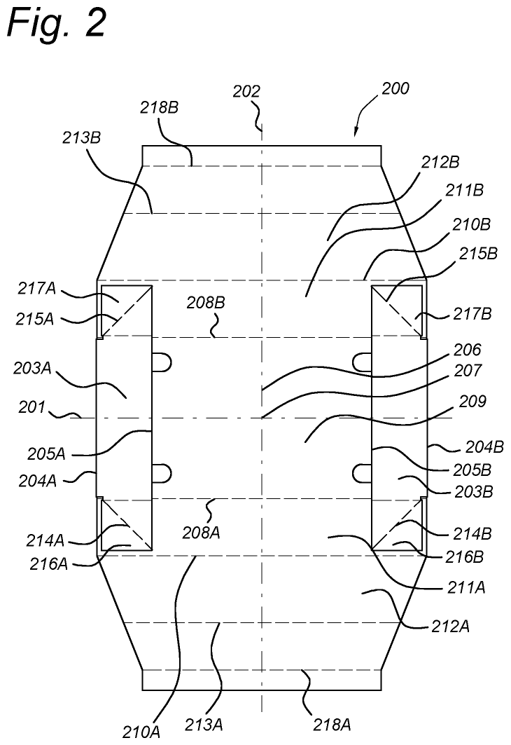

FIG. 2 shows an embodiment of a container template for use in the method of the present invention. Container template 200, shown in top view, is formed from preform 100 of FIG. 1 by folding the front panel 203A and the rear panel 203B back onto the top face of preform 100, and adhering the front panel and the rear panel to the top face of the template, as will be explained in more detail below. Reference numerals in FIG. 1 starting with a 1 correspond to the reference numerals in FIG. 2 starting with a 2.

Container template 200 has a longitudinal axis 201 and a transverse axis 202. Transverse axis 202 is perpendicular to longitudinal axis 201.

Front panel 203A is folded back onto the top face of container template 200 along fold line 204A; rear panel 203B is folded back onto the top face of container template along fold line 204B. Front panel 203A has an edge 205A running parallel to transverse axis 202. Rear panel 203B has an edge 205B running parallel to transverse axis 202. Front panel 203A and rear panel 203B leave a central area 206 of container template 200 uncovered. Central area 206 includes point 207, where longitudinal axis 201 and transverse axis 202 intersect.

The top face of container template 200 has a first score line 208A and a second score line 208B, which run parallel and equidistant to longitudinal axis 210. Fold lines 204A and 204B and score lines 208A and 208B define a bottom panel 209. Score lines 208A and 208B were made before front panel 203A and rear panel 203B were folded back onto the top face, so that these score lines continue into the front and rear panel all the way to edges 205A and 205B.

The top face of container template 200 has a third score line 210A and a fourth score line 210B parallel and equidistant to longitudinal axis 201. Score lines 208A and 210A together define a first side panel 211A. Score lines 208B and 210B together define a second side panel 211B.

Third score line 210A defines a first top panel 212A. Fourth score line 210B defines a second top panel 212B. First top panel 212A contains a score line 213A for articulating the first top panel. Second top panel 212B contains a score line 213B for articulating the second top panel.

Front panel 203A has a first diagonal score line 214A and a second diagonal score line 215A. Rear panel 203B has a first diagonal score line 214B and a second diagonal score line 215B. The diagonal score lines were made in the bottom face of preform 100 of FIG. 1, i.e. before front panel 203A and rear panel 203B were folded back onto the top face of the template.

The diagonal score lines define edge areas 216A, 217A, 216B, and 217B. The front and rear panels are adhered to the top face of container template 200 in these edge areas, for example with an adhesive.

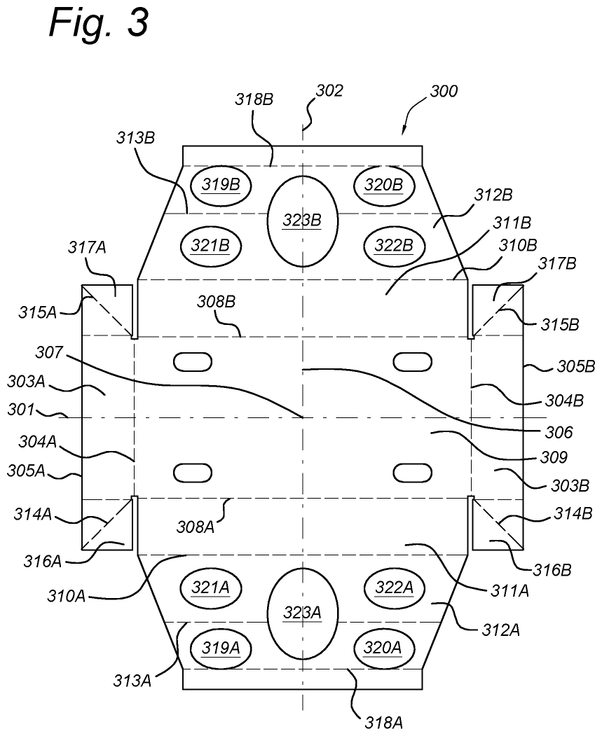

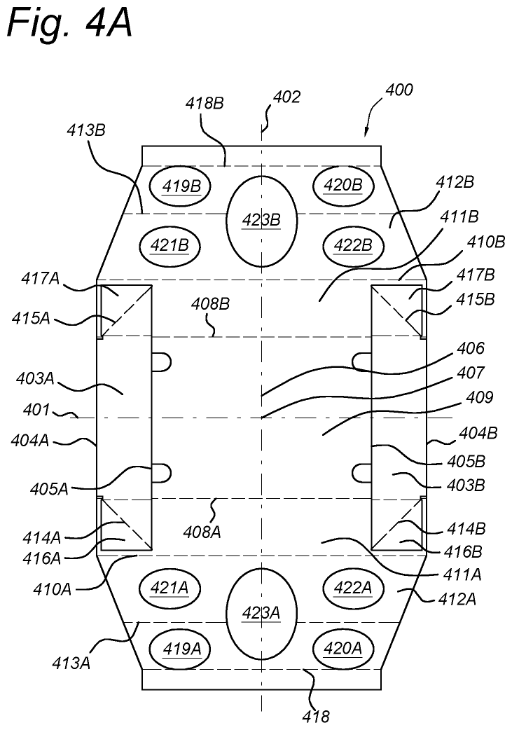

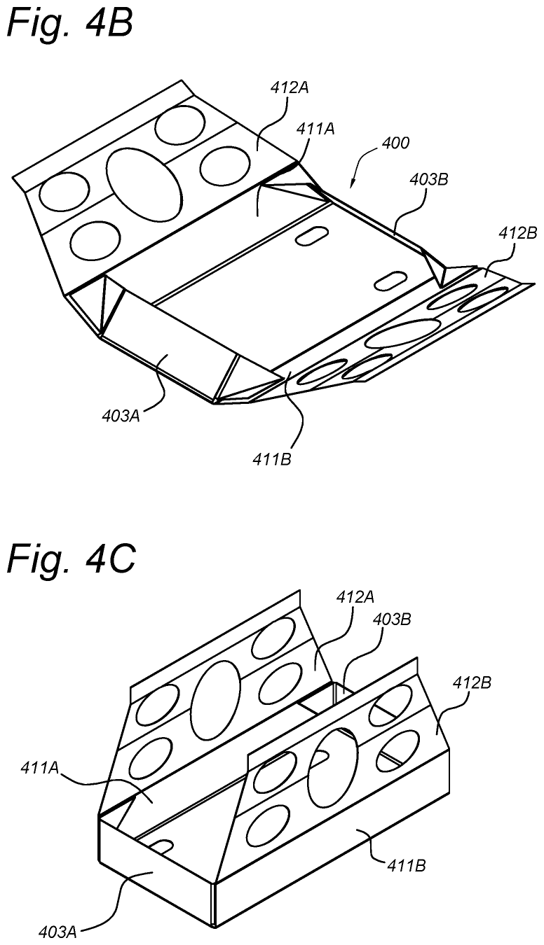

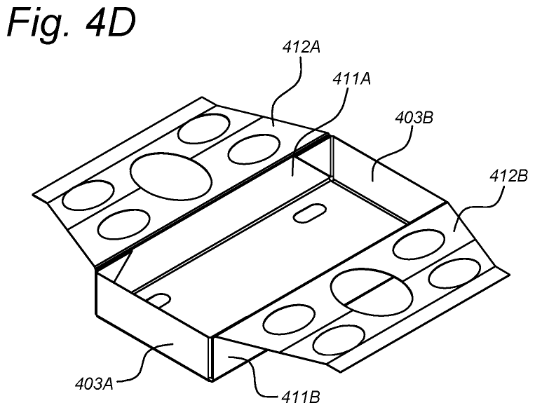

FIG. 4A shows an alternate embodiment of a container template 400. The 400-series numerals denote features corresponding to the 200-series numerals of FIG. 2. Container template 400, shown in top view, is formed from preform 300 of FIG. 3 by folding the front panel 403A and the rear panel 403B back onto the top face of preform 300, and adhering the front panel and the rear panel to the top face of the template.

As compared to container template 200, container template 400 has additional score lines 418A and 418B in the top panels. In addition, the top panels have holes 419A, 419B, 420A, 420B, 421A, 421B, 422A, 422B, 423A, and 423B. These holes provide visibility of a product that may be packaged in the container. Holes 423A and 423B may also serve as finger holes for carrying the container.

FIGS. 4B through 4E show consecutive stages of the formation of a container from container template 400.

In FIG. 4B, front panel 403A and rear panel 403B have been lifted off the top face of container template 400. As a result, side panels 411A and 411B have been lifted off the plane of container template 400, and with them top panels 412A and 412B, respectively.

FIG. 4C shows the configuration in which side panels 411A and 411B have been pushed inward to a substantial vertical position. As a result, front panel 403A, rear panel 403B and top panels 412A and 412B have adopted a substantially vertical position as well.

In FIG. 4D, top panels 412A and 412B have been folded outward, opening the container preform for receiving product.

In FIG. 4E, product (not shown) has been placed inside container preform 450. Top panels 412A and 412B have been folded back towards each other over the product in container 450. Score lines 410B and 418B, and corresponding score lines 410A and 418A in top panel 412A (not visible in FIG. 4E) allow the top panels to become articulated, so that their edges overlap in area 424. The edges of the two top panels are adhered to each other, for example with an adhesive or by adhering an adhesive label. The adhesive label may carry product information. When an adhesive label is used, the edges of the top panels may be made to abut instead of overlap.

By varying the amount of overlap of the edges of the top panels, the container can be made to accommodate products that vary in size. After product is placed in the container, the top panels are folded over the product so that the top panels touchingly engage the product. The amount of overlap is determined by the size of the product, with smaller product sizes leading to a larger area of overlap. Product is pre-sorted to make sure that the top panels will have some overlap, or at least come to an abutting configuration.

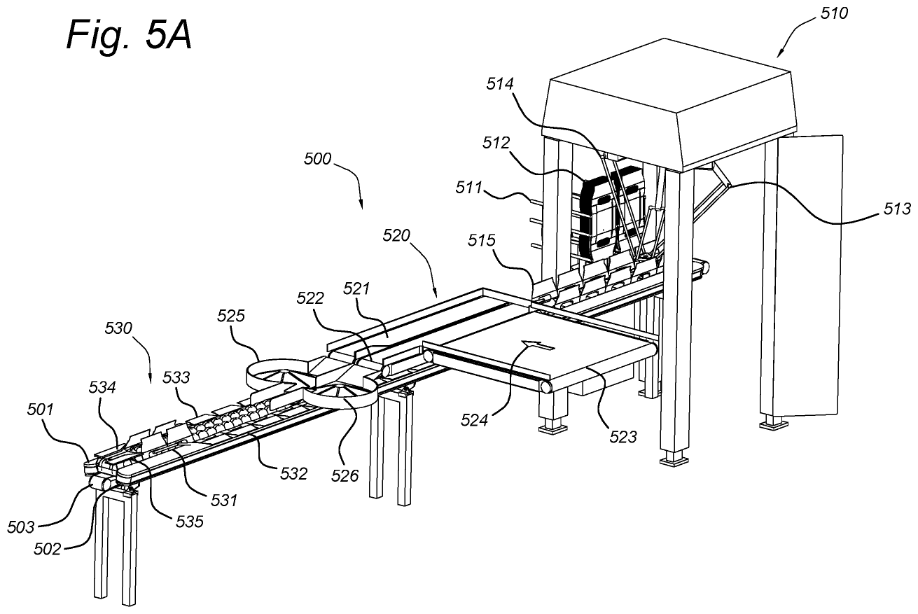

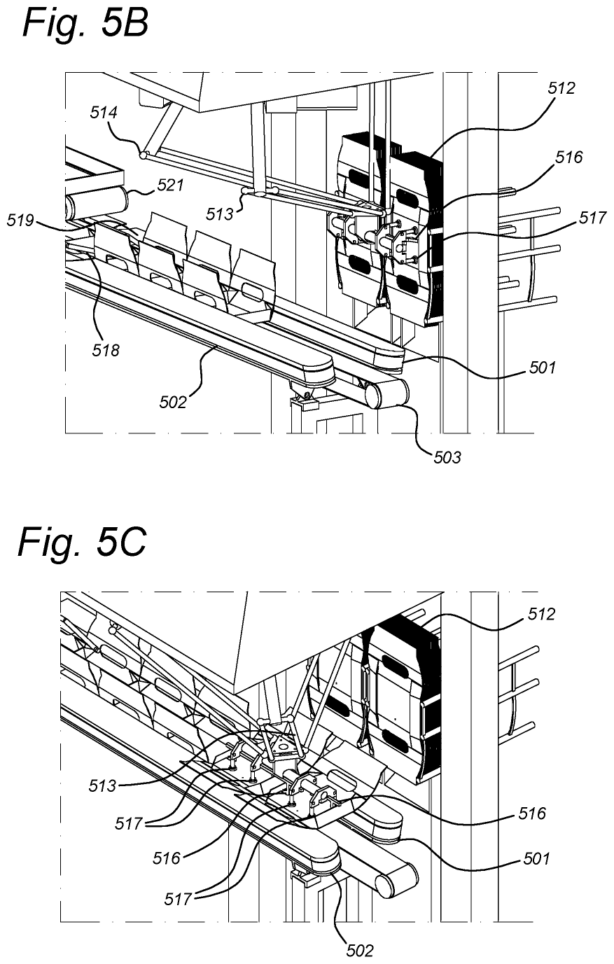

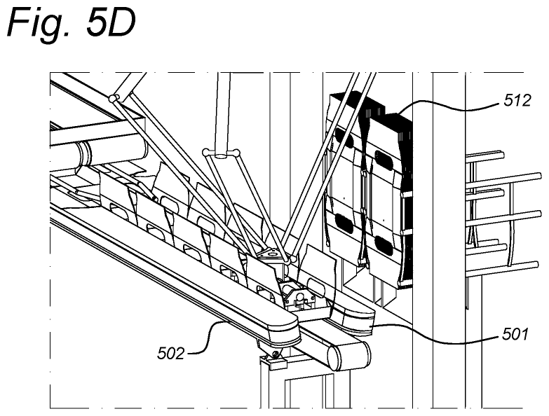

FIG. 5A shows a machine 500 for forming and filling the container of the present invention. Machine 500 comprises a container forming module 510, a container filling module 520, and a container closing module 530. Machine 500 comprises side conveyor belts 501 and 502, and bottom conveyor belt 503, for moving containers from forming module 510 through filling module 520 and through closing module 530.

Forming module 510 comprises a stack holder 511, which holds a stack of templates 512. Robot arms 513 and 514 are designed and configured to remove a template from stack 512, turn it 90 degrees, and push it down between side conveyor belts 501 and 502. The down pushing action forms a container preform, as explained in more detail with reference to FIGS. 4B and 4C, for example.

Next, the top panels of container 515 are folded outwardly (not shown) as container preform 515 is moved into filling module 520 by conveyor belts 501, 502, and 503.

Filling module 520 comprises two longitudinal conveyor belts 521 and a transverse conveyor belt 523. Product, for example apples, is deposited onto transverse conveyor belt 523, which transports it in the direction of arrow 524 onto longitudinal conveyor belts 521 and 522. Conveyor belts 521 and 522 move the product into trays 525 and 526, from which it drops into container preforms passing underneath.

Filled container preforms pass into closing module 530, where a pair of fingers 531 (only one shown) lift the top panels 532 and 533 of a container preform. Adhesive is applied to the top edge of top panel 533 (not shown). Finger 534 folds top panel 533 inward over the product. Top panel 532 is folded inward over the product by finger 535. Fingers 534 and 535 are arranged so that top panel 532 is on top of top panel 533 in the area where the two top panels overlap. The top edge of top panel 532 is adhered to the top edge of top panel 533 by means of the adhesive that is applied to top panel 533.

FIG. 5B shows a portion of the container forming module while the module is in operation. Robot arm 513 has moved grippers 516 into engagement with the proximal template of stack 512. Grippers 516 engage with the template by means of suction cups 517. In this embodiment two templates are manipulated simultaneously.

The two templates are to be placed in the free space between side conveyor belts 501 and 502, above conveyor belt 503. Fingers 518 and 519 push outwardly the top panels of a container preform that is about to move underneath conveyor belts 521 and 522 of the filling module.

In FIG. 5C two templates are being pushed into the space between side conveyor belts 501 and 502. The side panels of the templates have started to move to a vertical position. The configuration of the templates is similar to that of FIG. 4B.

In FIG. 5D the two templates have been pushed down fully into the space between side conveyor belts 501 and 502. The side panels of the templates are now substantially vertical. The configuration of the templates is similar to that of FIG. 4C. In the next moment the robot arms will start moving the grippers back to the stacks of templates.

Thus, the invention has been described by reference to certain embodiments discussed above. It will be recognized that these embodiments are susceptible to various modifications and alternative forms well known to those of skill in the art. For example, the closing of the container may be modified by adhering a label over the two top panels in the area where they overlap. In other embodiments the two top panels may be adhered to one another by stitching, punching, or a similar method.

Many modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A method for forming a covered cardboard container, filled with a product, said method comprising the steps of:
a. providing a container template, preferably as defined herein;
b. placing the container template in a receiving area of a packaging machine.
c. lifting the transverse edge of the front panel and the transverse edge of the rear panel off the top face of the container template, thereby folding upward the first side panel along the first score line and the second side panel along the second score line;
d. pushing the first side panel and the second side panel toward the longitudinal axis of the container template to a substantially vertical position, thereby forming a container preform;
e. placing the product inside the container preform;
f. folding the first top panel along the third score line toward the longitudinal axis of the container template and folding the second top panel along the fourth score line toward the longitudinal axis of the container template, thereby creating an area of overlap where a portion of the first top panel overlaps with a portion of the second top panel;
g. securing the first top panel to the second top panel in the area of overlap.

2. The method of claim 1 wherein step c. comprises:
c.1. sliding a finger under the transverse edge of the front panel and sliding a finger under the transverse edge of the rear panel;
c.2. lifting the fingers while holding down the bottom panel.

3. The method of claim 2 wherein the container template comprises finger holes along its longitudinal axis, said finger holes intersecting with the transverse edge of the front panel and the transverse edge of the rear panel, respectively, and the fingers are slid under the respective transverse edge at the location of a finger hole.

4. The method of claim 1 wherein step c. comprises:
c.1. supporting the container template in areas of the side panels while not supporting the bottom panel;
c.2. pushing down the bottom panel in the central area.

5. The method of any one of the preceding claims wherein, in step f., the first top panel and the second top panel are brought into touching engagement with the product.

6. The method of any one of the preceding claims wherein step g. comprises stitching, punching, gluing, or a combination thereof.

7. The method of any one of the preceding claims wherein step d. comprises conveying the container template in a direction of its longitudinal axis, by side belts engaging side panel areas of container template, said side belts converging to a distance slightly exceeding a dimension of the bottom panel in a direction of the transverse axis.

8. An apparatus for carrying out the method of any one of claims 1 through 7.

9. The apparatus of claim 8 comprising a robot arm provided with one or more suction cups for manipulating the container template.

10. The apparatus of claim 9 wherein the robot arm comprises a suction cup for engaging the container template in the central area.

11. The apparatus of claim 9 or 10 comprising suction cups for engaging the front panel and the rear panel, respectively.

12. The apparatus of claim 11 wherein the suction cups engaging the front panel and the rear panel act to lift the front panel and the rear panel off the top face of the container template in step b. of the method.

13. The apparatus of any one of claims 8 through 10 wherein the robot arm places the container template on a receiving area of the apparatus where the container template is supported in areas of the side panels and the bottom panel is not supported, and pushes down on the bottom panel in the central area.

14. The apparatus of any one of claims comprising folding means for folding the first top panel along the third score line toward the longitudinal axis of the container template and folding the second top panel along the fourth score line toward the longitudinal axis of the container template, thereby creating an area of overlap where a portion of the first top panel overlaps with a portion of the second top panel.

15. The apparatus of claim 14 wherein the folding means brings the top panels in touching engagement with the product.

16. A template for use in the method of any one of claims 1 through 7.
